(19) United States
(12) Patent Application Publication
(10) Pub. No.: US 2013/0290237 A1
(43) Pub. Date: Oct. 31, 2013

(54) DISCOVERY AND GROUPING OF RELATED COMPUTING RESOURCES USING MACHINE LEARNING

(71) Applicants: John A. Griffith, Austin, TX (US); Robert R. Peterson, Austin, TX (US); Philip R. Riedel, Cary, NC (US); David L. Schmidt, Cary, NC (US)

(72) Inventors: John A. Griffith, Austin, TX (US); Robert R. Peterson, Austin, TX (US); Philip R. Riedel, Cary, NC (US); David L. Schmidt, Cary, NC (US)

(73) Assignee: INTERNATIONAL BUSINESS MACHINES CORPORATION, Armonk, NY (US)

(21) Appl. No.: 13/458,281

(22) Filed: Apr. 27, 2012

(51) Int. Cl. G06N 5/02

(52) U.S. Cl. 706/47

(57) ABSTRACT

According to one aspect of the present disclosure a system and technique discovering and grouping related computing resources using machine learning is disclosed. The system includes a processor unit and logic executable by the processor unit to: receive a grouped unit of at least two configuration items of a computing environment; analyze the grouped unit to determine a correlation between the configuration items of the grouped unit; create a rule based on the determined correlation; apply the rule to the computing environment to identify another configuration item of the computing environment related to the configuration items of the grouped unit; and responsive to identifying another configuration item of the computing environment based on application of the rule, include the identified configuration item in the grouped unit.

### BACKGROUND

A data center may be used to represent an information technology (IT) or computing environment infrastructure. For example, a data center may be used to keep track of the physical and virtual machine inventory and the applications running throughout a computing environment. Thus, the data center serves as a repository for what is in the IT infrastructure such as switches, computer systems, and applications, as well as how they interact with each other. The data center can also be used to list and identify the various computing resources/objects, or configuration items, within a computing environment as well as their relationships and topologies. The data center may also be used to maintain a change history of configuration items along with a capability to snapshot versions to compare configuration items. Thus, the data center may enable an administrator to see changes to the data center over time. Using the data center, an administrator may also group computing resources or objects corresponding to certain business groups or projects.

### BRIEF SUMMARY

According to one aspect of the present disclosure a method and technique for a method and technique for discovering and grouping related computing resources using machine learning is disclosed. The method includes: receiving, by a discovery engine executing on a processor unit, a grouped unit of at least two configuration items of a computing environment; analyzing, by the discovery engine, the grouped unit to determine a correlation between the configuration items of the grouped unit; automatically creating a rule, by the discovery engine, based on the determined correlation; applying the rule, by the discovery engine, to automatically identify another configuration item of the computing environment related to the configuration items of the grouped unit; and responsive to identifying another configuration item of the computing environment based on application of the rule, including the identified configuration item in the grouped unit.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a data processing system for discovering and grouping related computing resources using machine learning in which illustrative embodiments of the present disclosure may be implemented; and

FIG. 4 is a flow diagram illustrating an embodiment of a method for discovering and grouping related computing resources using machine learning according to the present disclosure.

### DETAILED DESCRIPTION

Embodiments of the present disclosure provide a method, system and computer program product for discovering and grouping related computing resources using machine learning. For example, in some embodiments, the method and technique includes: receiving, by a discovery engine executing on a processor unit, a grouped unit of at least two configuration items of a computing environment; analyzing, by the discovery engine, the grouped unit to determine a correlation between the configuration items of the grouped unit; automatically creating a rule, by the discovery engine, based on the determined correlation; applying the rule, by the discovery engine, to automatically identify another configuration item of the computing environment related to the configuration items of the grouped unit; and responsive to identifying another configuration item of the computing environment based on application of the rule, including the identified configuration item in the grouped unit. Thus, in some embodiments of the present disclosure, machine learning techniques are used to analyze, discover and group related configuration items of a computing environment. For example, based on an initial grouping of computing environment resources or objects by a user/administrator, machine learning techniques are used to derive queries to automatically locate other computing resources of the computing environment that are likely related to the group. Based on a user/administrator's acceptance or rejection of the discovered items, the method responds to the acceptances/rejections by modifying and/or otherwise improving its queries for future inquiries/groupings.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

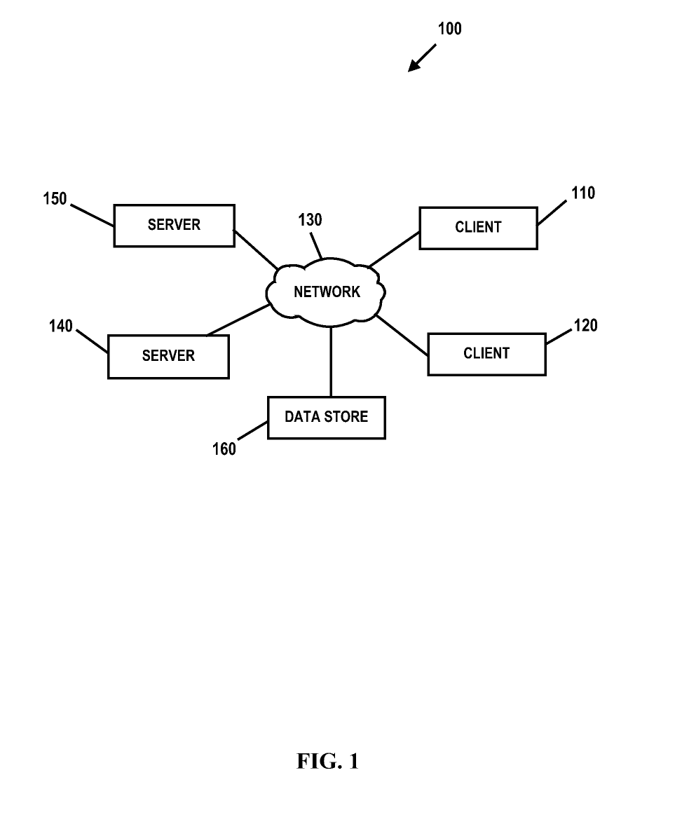

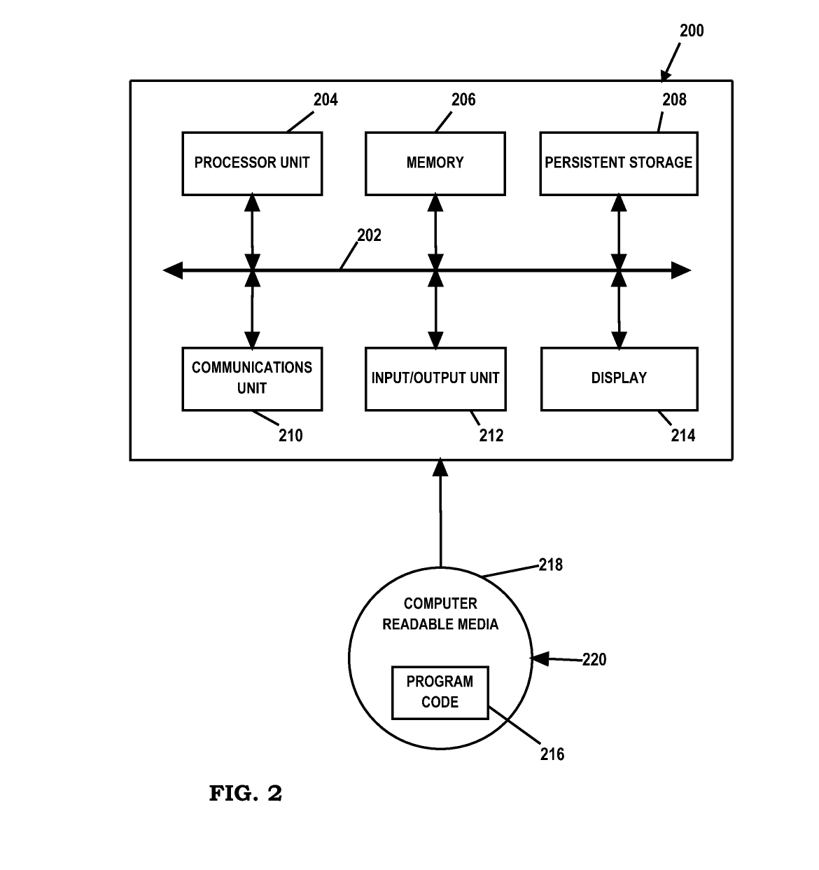

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. Server 140 and server 150 may be, for example, IBM® Power Systems™ servers. In addition, clients 110 and 120 connect to network 130. Clients 110 and 120 may be, for example, personal computers or network computers. In the depicted example, server 140 provides data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of a system for discovering and grouping related computing resources utilizing machine learning techniques according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

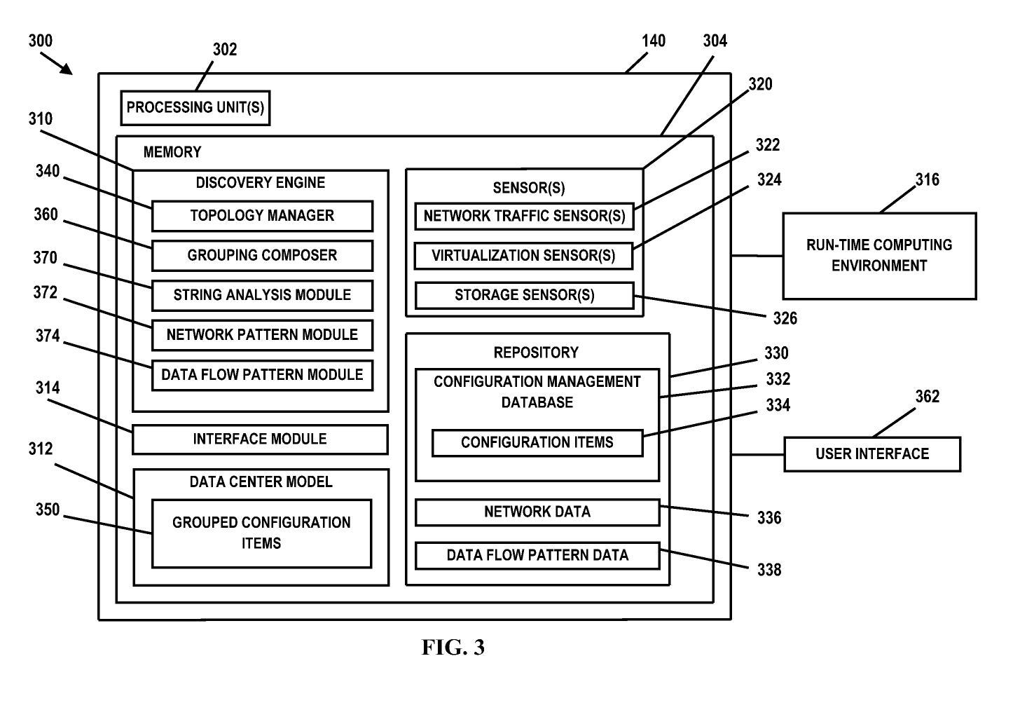

FIG. 3 is an illustrative embodiment of a system 300 for discovering and grouping related computing resources utilizing machine learning techniques. System 300 may be implemented on data processing systems or platforms such as, but not limited to, servers 140 and/or 150, clients 110 and/or 120, or at other data processing system locations. For example, in the embodiment illustrated in FIG. 3, an embodiment of system 300 is implemented on a data processing system such as server 140. It should be understood that embodiments of the present disclosure may be implemented elsewhere such as, but not limited to, client 110 and/or server 150.

In FIG. 3, system 300 includes one or more processor units 302 and a memory 304. In the embodiment illustrated in FIG. 3, memory 304 includes a discovery engine 310, a data center model 312 and an interface module 314. Discovery engine 310 is used to automatically discover and group various computing environment resources, items or objects associated with a computing environment. For example, in the embodiment illustrated in FIG. 3, server 140 is connected to a run-time computing environment 316. Computing environment 316 may comprise any type of computing environment and may include various types of hardware, software, virtual machines, switches, computer systems, and the like. Discovery engine 310 is configured to automatically discover the various computing resources of computing environment 316, referred to herein as “configuration items,” and automatically group certain configuration items based on a desired grouping criteria or model set forth or selected by a user/administrator. Interface module 314 may be used to display and/or otherwise present the various discovered and grouped CIs to a user/administrator. In the embodiment illustrated in FIG. 3, discovery engine 310 and interface module 314 are illustrated as being stored in memory 304 so as to be accessible and executable by one or more of processor units 302; however, it should be understood that discovery engine 310 and/or interface module 314 may be otherwise located, even remotely from server 140. Discovery engine 310 and/or interface module 314 may be implemented in any suitable manner using known techniques that may be hardware-based, software-based, or some combination of both. For example, discovery engine 310 and/or interface module 314 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

Data center model 312 represents a collection or grouping of the various configuration items of computing environment 316 that are associated with a desired grouping criteria or model. For example, data center model 312 may comprise a model representing the various types of computing resources or configuration items associated with a particular team or project of a business entity. Thus, a particular data center model 312 may comprise a model representing the various types of physical and virtual machine inventories and the applications running throughout computing environment 316 for a particular team or project including computing environment configuration items such as hardware, middleware, software, network switches, and the like.

In the embodiment illustrated in FIG. 3, system 300 includes one or more sensors 320 configured to poll and/or otherwise acquire various types of information associated with configuration items corresponding to computing environment 316. For example, in FIG. 3, sensors 320 include one or more network traffic sensors 322, one or more virtualization sensors 324, and one or more storage sensors 326. Network traffic sensors 322 may be used to discover network traffic information corresponding to computing environment 316. For example, network traffic sensors 322 may comprise flow-based, network profiling sensors used to analyze, aggregate and compile network flow data corresponding to computing environment 316. Virtualization sensors 324 may be used to analyze and/or acquire various information associated with virtual machines and/or software virtualizations corresponding to computing environment 316. Storage sensors 326 may be used to acquire various types of information associated with storage devices, the virtualization of such storage devices and/or storage or database software related to such storage devices associated with computing environment 316. It should be understood that additional and/or different types of sensors may be used in system 300 identify, aggregate and/or compile the various configuration items of computing environment 316.

In FIG. 3, server 140 also includes a repository 330 having a configuration management database 332. Configuration management database 332 may comprise a listing or compiled dataset of the various configuration items 334 discovered by discovery engine 310 using sensors 320. Repository 330 may also include network data 336 and data flow pattern data 338 acquired by one or more sensors 320. For example, network data 336 may comprise information associated with the various types of network devices and/or isolated network components or subnets corresponding to computing environment 316. Data flow pattern data 338 may comprise information associated with network packet flow between various endpoints in computing environment 316. It should be understood that additional and/or other types of information corresponding to various types of configuration items of computing environment 316 may be included in repository 330.

In some embodiments, discovery engine 310 may include a topology manager 340 configured to analyze the information in configuration management database 332, network data 336 and/or data flow pattern data 338 to generate a hardware topology corresponding to computing environment 316. For example, topology manager 340 may analyze information in repository 332 and identify and/or otherwise determine the various types of hardware configuration items corresponding to computing environment 316.

In operation, discovery engine 310 automatically discovers and/or otherwise identifies the various types of configuration items 334 corresponding to computing environment 316 using sensors 320 or other types of resources and stores such information corresponding to the discovered configuration items 334 in repository 330. Discovery engine 310 is also configured to automatically group various configuration items 334 that are related to each other based on a business unit, project or other type of grouping criteria. As will be described in further detail below, discovery engine 310 uses various types of machine learning techniques to automatically determine correlations between various types of configuration items 334 to determine which configuration items 334 to group together for a particular grouping criteria. In some embodiments, the various groups of configuration items 334 may be stored in a particular data center model 312 as grouped configuration items 350.

In some embodiments, discovery engine 310 also includes a grouping composer 360 to enable a user or administrator, via a user interface 362 generated and/or otherwise displayed by interface module 314, to initially form a grouped unit of various configuration items 334 based on a desired grouping criteria. Discovery engine 310 then “learns” from information acquired by grouping composer 360 to automatically create queries to submit to repository 330 based on identified and/or determined correlations of the grouped unit of configuration items received via grouping composer 360. For example, in some embodiments, a user/administrator may manually identify and group two or more configuration items 334 based on a desired grouping criteria using grouping composer 360 (e.g., identifying and grouping a server with corresponding software executing on such server). The grouped unit of configuration items 334 may be stored by grouping composer 360 as grouped configuration items 350. Discovery engine 310 then automatically evaluates the grouped unit of configuration items set forth as grouped configuration items 350 to determine a correlation between those grouped configuration items 350. Discovery engine 310 analyzes the grouped configuration items 352 to identify and/or determine patterns to enable rules to be derived based on the grouped configuration items 350 correlations. The derived rules are then used to automatically build queries on behalf of the user by discovery engine 310 to automatically locate and group additional configuration items 334 with the previously grouped configuration items 350 (e.g., without further user intervention or action). Discovery engine 310 builds the queries and submits the queries to repository 330 (e.g., configuration management database 332, network data 336 and/or data flow pattern data 338) to automatically locate, identify and group with the previously grouped configuration items 350 additional or new configuration items 334 of computing environment 316. Thus, discovery engine 310 is configured to perform new groupings of configuration items automatically based on the rules and queries that have been derived by discovery engine 310 based on the correlations discovered/identified by discovery engine 310 from the previously grouped configuration items.

According to the present disclosure, in response to receiving a grouping of configuration items (e.g., from a user and/or administrator via grouping composer 360), discovery engine 310 utilizes one or more machine learning algorithms to detect patterns indicating a correlation between the grouped unit of configuration items. For example, in the embodiment illustrated in FIG. 3, discovery engine 310 includes a string analysis module 370, a network pattern module 372 and a data flow pattern module 374. String analysis module 370 is used to discover and analyze text metadata associated with the grouped unit of configuration items 350. For example, discovery engine 310 may discover an application server and store information corresponding to the server, node, profile, cell names, names of applications running on the server and numerous other types of text metadata corresponding to the discovered application server in repository 330. In response to receiving a grouped unit of configuration items as grouped configuration items 350, string analysis module 370 may evaluate the text metadata associated with one or more of the grouped configuration items 350, derive a rule based on the text metadata associated with the grouped configuration items 350, generate a query based on the text metadata rule, and submit the query to repository 330 in an attempt to locate and/or otherwise identify other configuration items 334 that may be related to the previously grouped configuration items 350 based on such text metadata. For example, the rule derived based on the grouped unit of configuration items may define one or more text metadata strings as defining configuration items that should be grouped together. Thus, in operation, string analysis module 370 may be used to perform text metadata or text string comparisons based on the derived rule to identify and/or otherwise locate other configuration items 334 from repository 332 having the same or similar text metadata to automatically group with the previously grouped unit of configuration items 350.

Network pattern module 372 may be used to analyze network data 336 acquired by network traffic sensors 322 to identify various types of network-related information corresponding to the previously grouped configuration items 350. For example, based on the grouped unit of configuration items 350, network pattern module 372 may evaluate network data 336 to identify network hops, subnet information, or other network pattern information corresponding to one or more configuration items of the grouped unit of configuration items 350. Thus, network pattern module 372 may then use network data 336 to derive a rule based on a network-related information of the grouped configuration items 350 (e.g., identifying one or more subnets as defining a potential relationship among configuration items) and then generate a query based on such rule to submit to repository 330 in an attempt to locate and/or otherwise identify other configuration items 344 that may be related to the grouped unit of configuration items 350 based on such network data 336 (e.g., within the same subnets).

Data flow pattern module 374 may be used to analyze data flow pattern data 338 to identify data flow patterns corresponding to the grouped unit of configuration items 350. For example, data flow pattern data 338 may comprise packet flow information among and/or between endpoints within computing environment 316 that may be used to identify additional configuration items 334 that may be related to one or more configuration items of the grouped unit of configuration items 350. In response to analyzing flow pattern data 338 corresponding to the grouped unit of configuration items 350, data flow pattern module 374 derives a rule based on such data flow patterns (e.g., defining certain network endpoints and/or throughpoints being associated with grouped unit information transfer) and generates a query based on such rule to submit to repository 330 in an attempt to locate and/or otherwise identify other configuration items 344 that may be related to the previously grouped configuration items 330 based on such data flow patterns (e.g., configuration items participating in such data transfers and/or sending/receiving communications along certain data flow routes). For example, data flow pattern module 374 may use flow pattern data 338 to identify associations among machines and/or applications that have observed data flow traffic above some nominal threshold.

In response to the submission of one or more queries to repository 330 and the responses thereto, discovery engine 310 automatically locates and/or otherwise identifies one or more additional configuration items 334 to group with previously grouped unit of configuration items 350. In some embodiments, the results or responses of the queries to repository 330 may be displayed to a user or administrator via grouping composer 360 to enable the user or administrator to accept or reject the groupings performed automatically by discovery engine 310. In response to receiving an acceptance or rejection of a grouping performed automatically by discovery engine 310, discovery engine 310 may automatically revise or modify a previously derived rule based on a previous correlation of grouped configuration items 350. Thus, in some embodiments, based on corrections made by a user/administrator to an automatic grouping of configuration items performed by discovery engine 310, discovery engine 310 automatically adapts and/or otherwise “learns” from such corrections and modifies previously derived rules and queries accordingly. Based on such rule corrections or modifications, discovery engine 310 may automatically derive and submit modified queries to repository 330 to locate other configuration items 334 to group with previously grouped configuration items 350.

As an example of the foregoing, consider that an administrator has used discovery engine 310 to discover and classify all hardware and software in a particular computing environment 316. The discovered hardware and software may be stored in repository 330 as configuration items 334. The discovered configuration items 334 may include network switches, computer systems, databases, storage devices, virtual machines, middleware software, software applications, etc. Discovery engine 310 may further be used by the administrator to organize the discovered configuration items 334 into a desired group (e.g., associated with a core business group, such as payroll). Using grouping composer 360 via user interface 362, the administrator may make an initial manual grouping of certain configuration items 334 into a grouped unit. For example, under a data center model 312 called “payroll,” the administrator may group together the following configuration items 334:
computer systems: es2490, es2491, es2492; and
software: HTTP server software (four instances), enterprise software (four instances), database software (three instances), authentication/access software, messaging software.
   The above-referenced configuration items are simplified representations as these items may include significant amounts of metadata (for example, the application servers may include metadata corresponding to the computer systems they are running on, cell/node names, and the applications listed running on them).

Based on the initial grouping of configuration items 332 set forth by the administrator as a grouped unit of configuration items 350, discovery engine 310 analyzes the grouped configuration items 350 and creates relationship rules associated with patterns derived from the grouped configuration items 350. For example, string analysis module 370 may perform a text string metadata analysis and determine that the grouped configuration items 350 include server names that share the same first two letters “es”. Network pattern module 372 may analyze the grouped configuration items 350 and, based on network data 336 corresponding to the grouped configuration items 350, determine that the database devices, database software and application servers are in the same subnet. String analysis module 370 may also detect that the computer system running the enterprise software is in the metadata discovered from the application servers, thereby indicating an association therebetween. Data flow pattern module 374 may evaluate the grouped unit of configuration items 350 to identify data flow patterns associated with one or more configuration items of the grouped unit (e.g., identifying data packet flow to and/or from one or more configuration items of the grouped unit).

Based on the patterns and correlations derived by discovery engine 310 of the grouped unit of configuration items 350 provided by the administrator, discovery engine 310 derives correlation or relationship rules based on the grouped configuration items 350 and creates candidate queries to submit to repository 330 in an attempt to identify other configuration items 334 that may be related to the previously grouped configuration items 350. Discovery engine 310 submits the queries to repository 330 and, based on a response to the queries, automatically forms a new grouped unit of configuration items by grouping any newly discovered configuration items 334 with the previously grouped configuration items 350. In some embodiments, discovery engine 310 may display to the administrator the new grouped unit of configuration items for either acceptance or rejection by the administrator. For example, the administrator may notice that one or more newly discovered configuration items discovered by discovery engine 310 should not be included with the previously grouped configuration items 350. Using grouping composer 360, the administrator may remove such configuration items from the grouping. Discovery engine 310 may then modify and/or optimize the previously derived rules based on the modifications made by the administrator (e.g., invalidating a rule and/or modifying a rule). Thus, each correction or modification made by the administrator increases the accuracy of discovery engine 310 to locate other configuration items 334 that should be grouped with the previously grouped configuration items 350.

In some embodiments, discovery engine 310 may be configured to display or otherwise present the derived queries to a user/administrator to enable the user/administrator to modify and/or correct such queries. For example, discovery engine 310 may display or otherwise present the derived queries to the user/administrator to enable the user/administrator to accept, reject or edit such queries before submitting such queries to repository 330. Thus, for example, the user/administrator may modify query semantics or syntax to optimize the queries submitted to repository 330.

In some embodiments, discovery engine 310 may derive numerous queries based on the analysis of the grouped unit of configuration items 350 and submit numerous queries to repository 330 before returning the results of the queries to a user/administrator. For example, in some embodiments, discovery engine 310 may combine the results of one or more rule derivations (e.g., deriving a rule based on data flow patterns within a particular subnet, deriving a rule based on metadata for configuration items within a particular subnet, etc.) and generate queries based on such rule combinations. Further, in some embodiments, discovery engine 310 may weight some correlation patterns differently relative to other correlation patterns. For example, in some embodiments, discovery engine 310 may weight text metadata greater than discovered subnet relationships to define rules for searching for other related configuration items. Thus, it should be understood that various types of algorithms may be employed and evaluated by discovery engine 310 to determine patterns and/or correlations between configuration items to enable discovery engine 310 to include such items within a grouped unit or prevent certain items from being included in a grouped unit. For example, in some embodiments, even though discovery engine 310 may identify a particular configuration item having text string metadata matching one or more configuration items already included in a grouped unit, network data 336 may indicate that such item should not be part of the grouped unit. A rule may also be applied to a configuration item discovered in response to a rule/query. For example, in some embodiments, discovery engine 310 may submit a query to repository 330 and identify another configuration item 334 based on such query that may be related to the grouped unit (e.g., based on a metadata analysis). Discovery engine 310 may then apply another rule (e.g., a network data rule and/or data flow pattern rule) to determine whether the identified configuration item should be included in the grouped unit (e.g., even though metadata may indicate the inclusion of the item in the grouped unit, network data 336 and/or data flow pattern data 338 may indicate otherwise).

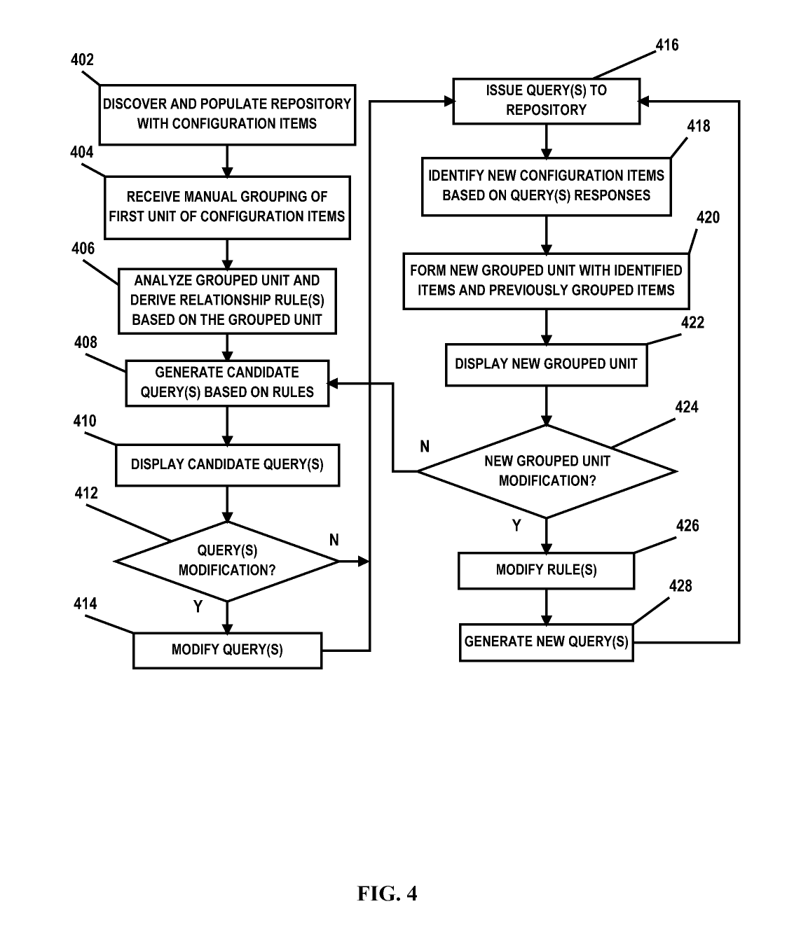

FIG. 4 is a flow diagram illustrating an embodiment of a method for discovering and grouping related computing resources utilizing machine learning techniques according to the present disclosure. The method begins at block 402, where discovery engine 310 discovers and populates repository 330 with configuration items 334 corresponding to computing environment 316. Discovery engine 310 may also acquire and store in repository 330 network data 336 and/or data flow pattern data 338 corresponding to computing environment 316. At block 404, discovery engine 310 receives a manual grouping of a first unit of configuration items 334. For example, using grouping composer 360, a user/administrator may select certain ones of configuration items 334 to initially group together in a grouped unit based on a desired grouping criteria (e.g., business unit, task or project, etc.). At block 406, discovery engine 310 analyzes the grouped unit of configuration items and derives relationship rules based on the grouped unit. At block 408, discovery engine 310 generate candidate queries based on the rules to locate and/or identify additional configuration items 334 for the desired grouping criteria.

At block 410, discovery engine 310 displays and/or otherwise provides a user/administrator with the generated candidate queries. At the decisional block 412, a determination is made whether the user/administrator seeks a modification to the queries generated by discovery engine 310. If no query modifications are input by the user/administrator, the method proceeds to block 416. If a query modifications is desired, the method proceeds from decisional block 412 to block 414, where discovery engine 310 modifies the corresponding queries as indicated by the user/administrator. The method then proceeds to block 416.

At block 416, discovery engine 310 issues the queries to repository 330 and/or otherwise polls repository 330 based on such queries. At block 418, discovery engine 310 identifies new configuration items based on the results or responses to the queries. At block 420, discovery engine 310 forms a new grouped unit of configuration items by combining the newly identified configuration items with the previously grouped unit of configuration items. At block 422, discovery engine 310 displays the new grouped unit of configuration items to the user/administrator. At decisional block 424, a determination is made whether a modification to the new grouped unit is needed. For example, the new grouped unit may be displayed to the user/administrator for acceptance or rejection of the new grouped unit (e.g., enabling the user/administrator to remove certain configuration items and/or add other configuration items to the new grouped unit). If no modification is needed, the method proceeds to block 408, where discovery engine 310 may generate new queries based on the new grouped unit. If a modification to the new grouped unit is needed, such as the removal and/or addition of certain configuration items relative to the new grouped unit, the method proceeds to block 426, where discovery engine 310 modifies previously derived rules based on the modified grouped unit. At block 428, discovery engine 310 generates new queries based on the modified rules. The method then proceeds to block 416, where discovery engine 310 may issue the modified queries to repository 330 in an attempt to identify and/or otherwise locate additional configuration items 334 to include in the grouped unit.

Thus, embodiments of the present disclosure enable an automated method to determine which computing resources of a computing environment are correlated. For example, embodiments of the present disclosure enable the automatic derivation and/or generation of queries used to discover configuration items that are correlated without the user/administrator being familiar with or experienced with the various naming conventions and query semantics that may be needed to identify such configuration items. Further, embodiments of the present disclosure enable large computing environments (e.g., containing thousands of configuration items) to be evaluated and related configuration items grouped together without repeated and burdensome manual groupings being performed by the user/administrator. Thus, embodiments of the present disclosure provide a method and system using machine learning techniques to analyze, discover and group related configuration items of a computing environment.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-7. (canceled)

8. A system, comprising:
a processor unit;
logic executable by the processor unit to:
receive a grouped unit of at least two configuration items of a computing environment;
analyze the grouped unit to determine a correlation between the configuration items of the grouped unit;
create a rule based on the determined correlation;
apply the rule to the computing environment to identify another configuration item of the computing environment related to the configuration items of the grouped unit; and
responsive to identifying another configuration item of the computing environment based on application of the rule, include the identified configuration item in the grouped unit.

9. The system of claim 8, wherein the logic is executable to create the rule based on text metadata of at least one of the configuration items of the grouped unit.

10. The system of claim 8, wherein the logic is executable to create the rule based on a network pattern associated with at least one of the configuration items of the grouped unit.

11. The system of claim 8, wherein the logic is executable to create the rule based on a data flow pattern corresponding to at least one of the configuration items of the grouped unit.

12. The system of claim 8, wherein the logic is executable to:
display the grouped unit with the identified configuration item based on the rule application;
receive an acceptance or rejection of the identified configuration item for the grouped unit; and
responsive to receiving the acceptance or rejection, modify the rule based on the acceptance or rejection.

13. The system of claim 8, wherein the logic is executable to apply the rule by querying a repository of configuration items associated with the computing environment.

14. The system of claim 8, wherein the logic is executable to:
display the rule to a user;
receive a modification to the rule from the user; and
apply the modified rule to the computing environment.

15. A computer program product for identifying and grouping computing resources, the computer program product comprising:
a computer readable storage medium having computer readable program code embodied therewith, the computer readable program code comprising computer readable program code configured to:
receive a grouped unit of at least two configuration items of a computing environment;
analyze the grouped unit to determine a correlation between the configuration items of the grouped unit;
create a rule based on the determined correlation;
apply the rule to the computing environment to identify another configuration item of the computing environment related to the configuration items of the grouped unit; and
responsive to identifying another configuration item of the computing environment based on application of the rule, include the identified configuration item in the grouped unit.

16. The computer program product of claim 15, wherein the computer readable program code is configured to create the rule based on text metadata of at least one of the configuration items of the grouped unit.

17. The computer program product of claim 16, wherein the computer readable program code is configured to create the rule further based on a network pattern associated with at least one of the configuration items of the grouped unit.

18. The computer program product of claim 17, wherein the computer readable program code is configured to further create the rule based on a data flow pattern corresponding to at least one of the configuration items of the grouped unit.

19. The computer program product of claim 15, wherein the computer readable program code is configured to:
display the grouped unit with the identified configuration item based on the rule application;
receive an acceptance or rejection of the identified configuration item for the grouped unit; and
responsive to receiving the acceptance or rejection, modify the rule based on the acceptance or rejection.

20-25. (canceled)
